(19) United States
(12) Patent Application Publication
(10) Pub. No.: US 2026/0063272 A1
(43) Pub. Date: Mar. 5, 2026

(54) COATING LAMP STRIP CAPABLE OF IMPROVING LUMINOUS EFFICIENCY, COATING MATERIAL FOR LAMP STRIP, AND PREPARATION METHOD FOR COATING LAMP STRIP CAPABLE OF IMPROVING LUMINOUS EFFICIENCY

(71) Applicant: General Lighting Electronic Co., Ltd., Zhongshan (CN)

(72) Inventor: Jiuhuai XIE, Loudi (CN)

(73) Assignee: General Lighting Electronic Co., Ltd., Zhongshan (CN)

(21) Appl. No.: 18/895,109

(22) Filed: Sep. 24, 2024

(30) Foreign Application Priority Data
Aug. 30, 2024 (CN) 2024112085150

(51) Int. Cl. F21V 9/40; F21Y 103/10; F21Y 115/10

(52) U.S. Cl. CPC F21V 9/40; F21Y 2103/10; F21Y 2115/10

(57) ABSTRACT

The present invention provides a coating lamp strip capable of improving luminous efficiency, including a light source strip, and a coating adhesive that externally covers/encapsulates the light source strip, where the coating adhesive is made of an extrudable organo-silicon elastic material, which is black or gray at normal temperature, has a temperature-sensing characteristic, may change color as temperature increases, and gradually changes from black to white-like. According to the present invention, a color-changeable organo-silicon elastic material with a temperature-sensing characteristic is adopted as a coating adhesive, and the coating adhesive coats the outside of a light source strip to form a coating lamp strip. The coating adhesive of the coating lamp strip is black or gray when the lamp strip is not lightened at normal temperature.

### CROSS-REFERENCE TO RELATED APPLICATIONS

The application claims priority to Chinese patent application No. 2024112085150, filed on Aug. 30, 2024, the entire contents of which are incorporated herein by reference.

### TECHNICAL FIELD

The present invention relates to the field of LED lamp strips, and in particular, to a coating lamp strip capable of improving luminous efficiency, a coating material for a lamp strip, and a preparation method for the coating lamp strip capable of improving luminous efficiency.

### BACKGROUND

An existing general decorative strip is only a decorative strip and cannot emit light, which cannot achieve the effect of lighting. The silica gel and the LED lamp strip are combined to form a new type of lamp, which is called as a silica gel lamp strip. With the continuous and rapid development of LED market scale, the demand for silica gel flexible lamp strips applied to different LED products is increasing, and continues to grow. The application scenario of silica gel lamp strip is very wide, and has been widely applied to decorative designs such as home decoration, shop decoration, urban lighting, bridge lighting, building lighting, and highway warning. The silica gel lamp strip can also be used as a lighting fixture, and is applicable to roads, courtyards, stairs, ceilings, automobiles, ponds, underwater, advertising signboards and the like.

The silica gel lamp strip, when used as decorative lighting, is generally selected to be transparent or opalescent. The light transmittance of a transparent silica gel lamp strip exceeds 90%. An opalescent silica gel lamp strip has a light transmittance of 64%-70%, uniform light emission and pure and bright light color. Since the light transmittance of a black silica gel lamp strip is low, when used as decorative lighting, the black silica gel lamp strip is in a very awkward position. The decoration needs black to be decorated, but a lighting level is barely satisfactory.

In view of the above problems, we have developed a coating lamp strip capable of improving luminous efficiency.

### SUMMARY

The present invention aims to at least solve one of the technical problems existing in the prior art. Therefore, the present invention provides a coating lamp strip capable of improving luminous efficiency, a coating material for a lamp strip, and a preparation method for the coating lamp strip capable of improving luminous efficiency. The technical solution adopted is as follows:

A coating lamp strip capable of improving luminous efficiency includes a light source strip, and a coating adhesive that externally covers/encapsulates the light source strip, where the coating adhesive is made of an extrudable organo-silicon elastic material, which is black or gray at normal temperature, has a temperature-sensing characteristic, may change color as temperature increases, and gradually changes from black to white-like.

A coating material for a lamp strip includes the following raw materials in parts by mass:

| | | |
|---|---|---|
| siloxane composition | 95-97 | parts |
| diffusion agent | 2-5 | parts; |

then, temperature change powder with a proportion of 1.5-2% was added on the basis of the total number of the parts by mass.

The coating material for a lamp strip according to an embodiment of the present invention, the siloxane composition includes the following raw materials in parts by mass:

| | | |
|---|---|---|
| polysiloxanes, di-me, me vinyl, vinyl group-terminated | 50-95 | parts |
| silicon dioxide | 5-50 | parts |
| hydroxyl-terminated polydimethylsiloxane | 0-0.8 | parts |
| auxiliary agent | 0.3-0.8 | parts. |

The coating material for a lamp strip according to an embodiment of the present invention, the diffusion agent includes the following raw materials in parts by mass:

| | | |
|---|---|---|
| organo-silicon polymer | 15-20 | parts |
| diffusion powder | 75-70 | parts |
| structural agent | 6-8 | parts |
| dispersing agent | 2-4 | parts. |

The coating material for a lamp strip according to an embodiment of the present invention, the organo-silicon polymer is polydimethylsiloxane.

The coating material for a lamp strip according to an embodiment of the present invention, the diffusion powder is quartz powder.

The coating material for a lamp strip according to an embodiment of the present invention, the structural agent is room temperature vulcanized silicone rubber.

The coating material for a lamp strip according to an embodiment of the present invention, the dispersing agent is dimethicone.

The coating material for a lamp strip according to an embodiment of the present invention, the temperature change powder includes the following raw materials in parts by mass:

| | | |
|---|---|---|
| isobutylphenoxy epoxy resin | 40-60 | parts |
| fatty acid compound | 50-70 | parts |
| color-changing dye | 1-10 | parts |
| color developing agent | 1-10 | parts |
| auxiliary agent | 1-10 | parts. |

A preparation method for a coating lamp strip capable of improving luminous efficiency, a process includes the following steps;
step A: preparing a light source strip;
step B: preparing a siloxane composition, a diffusion agent, and temperature change powder, and mixing a coating adhesive through a mixer;
step C: placing the light source strip into a forming mould on an extruder, starting the extruder and feeding a mixed coating adhesive, and extruding a coating adhesive film until the coating adhesive film uniformly wraps the light source strip;
step D: starting a vacuum film coating device to completely and tightly attach the coating adhesive film and to coat the light source strip; and
step E: feeding the film-coated light source strip into a constant-temperature furnace for curing and molding, where the temperature of the constant-temperature furnace is 140° C.-180° C.

Compared with the prior art, beneficial effects of the present invention are as follows:

According to the present invention, a color-changeable organo-silicon elastic material with a temperature-sensing characteristic is adopted as a coating adhesive, and the coating adhesive coats the outside of a light source strip to form a coating lamp strip. The coating adhesive of the coating lamp strip is black or gray when the lamp strip is not lightened at normal temperature. After the lamp strip is lightened, heating can cause the coating adhesive to change color along with the increase of temperature, and the initial black or gray gradually becomes white and even transparent, so that the light transmittance of the coating lamp strip is greatly improved, and the luminous efficiency is greatly improved. After the lamp is turned off, the coating adhesive recovers to its original state with the decrease of temperature. The coating lamp strip provided by the invention has a decorative effect when the lamp is turned off, and plays a role in linear illumination and decorative illumination after the lamp is turned on. According to the invention, linear illumination and building decoration are perfectly combined, so that the corresponding cost is saved for a user, and a highly integrated effect is achieved on the decorative aesthetics.

### BRIEF DESCRIPTION OF THE DRAWINGS

FIG. 1 is a luminous efficiency rise curve in accordance with some embodiments.

### DETAILED DESCRIPTION OF THE EMBODIMENTS

To make it easy to understand the technical means, creative features, purposes, and effects of the present invention, the following further describes the present invention in combination with specific embodiments.

A coating lamp strip capable of improving luminous efficiency includes a light source strip, and a coating adhesive that externally covers/encapsulates the light source strip, where the coating adhesive is made of an extrudable organo-silicon elastic material, which is black or gray at normal temperature, has a temperature-sensing characteristic, may change color as temperature increases, and gradually changes from black to white-like.

According to the present invention, a color-changeable organo-silicon elastic material with a temperature-sensing characteristic is adopted as a coating adhesive, and the coating adhesive coats the outside of a light source strip (an LED light strip or an OLED light strip) to form a coating lamp strip. The coating adhesive of the coating lamp strip is black or gray when the lamp strip is not lightened at normal temperature. After the lamp strip is lightened, heating can cause the coating adhesive to change color along with the increase of temperature, and the initial black or gray gradually becomes white and even transparent, so that the light transmittance of the coating lamp strip is greatly improved, and the luminous efficiency is greatly improved. After the lamp is turned off, the coating adhesive recovers to its original state with the decrease of temperature. The coating lamp strip provided by the invention is black or gray when the lamp is turned off, and has a decorative effect. After the lamp is turned on, the coating adhesive is gradually thermochromic into white-like and transparent, so that the light transmittance is gradually improved. In this case, the coating lamp strip plays a role in linear illumination and decorative illumination. According to the invention, linear illumination and building decoration are perfectly combined, so that the corresponding cost is saved for a user, and a highly integrated effect is achieved on the decorative aesthetics.

A coating material for a lamp strip, which is used for preparing the above coating adhesive, includes the following raw materials in parts by mass:

| | | |
|---|---|---|
| siloxane composition | 95-97 | parts |
| diffusion agent | 2-5 | parts; |

then, temperature change powder with a proportion of 1.5-2% was added on the basis of the total number of the parts by mass.

A specific preparation method for a coating lamp strip includes the following strips:
step A: preparing an LED lamp strip;
step B: preparing a siloxane composition, a diffusion agent, and temperature change powder (that is, coating material), and mixing a coating adhesive through a mixer;
step C: placing the LED lamp strip into a forming mould on an extruder, starting the extruder and feeding a mixed coating adhesive, and extruding a coating adhesive film until the coating adhesive film uniformly wraps the LED lamp strip;
step D: starting a vacuum film coating device to completely and tightly attach the coating adhesive film and to coat the LED lamp strip; and
step E: feeding the film-coated LED lamp strip into a constant-temperature furnace for curing and molding, where the temperature of the constant-temperature furnace is 160° C., and the coating lamp strip is obtained after constant-temperature curing.

The siloxane composition in the coating material for the lamp strip includes the following raw materials in parts by mass:

| | | |
|---|---|---|
| polysiloxanes, di-me, me vinyl, vinyl group-terminated | 50-95 | parts |
| silicon dioxide | 5-50 | parts |
| hydroxyl-terminated polydimethylsiloxane | 0-0.8 | parts |
| auxiliary agent | 0.3-0.8 | parts. |

The diffusion agent in the coating material for the lamp strip includes the following raw materials in parts by mass:

| | | |
|---|---|---|
| organo-silicon polymer | 15-20 | parts |
| diffusion powder | 75-70 | parts |
| structural agent | 6-8 | parts |
| dispersing agent | 2-4 | parts, |

where the organo-silicon polymer is polydimethylsiloxane, the diffusion powder is quartz powder, the structural agent is room temperature vulcanized silicone rubber, and the dispersing agent is dimethicone.

The temperature change powder in the coating material for the lamp strip includes the following raw materials in parts by mass:

| | | |
|---|---|---|
| isobutylphenoxy epoxy resin | 40-60 | parts |
| fatty acid compound | 50-70 | parts |
| color-changing dye | 1-10 | parts |
| color developing agent | 1-10 | parts |
| auxiliary agent | 1-10 | parts. |

The color-changing temperature of the temperature change powder is 35° C., and the thermal decomposition temperature is above 250° C.

Now, a plurality of groups of various materials within the above mass fraction range are selected to prepare the siloxane composition, the diffusion agent and the temperature change powder, respectively, and then the siloxane composition, the diffusion agent and the temperature change powder within the mass fraction of the coating material for the plurality of groups of lamp strips are selected. The plurality of groups of coating lamp strips are prepared according to the specific preparation method for the coating lamp strips, which are respectively numbered as IM, IM1, 1M2, 1M3, 1M4, 1M5, 1M6, 1M7, 1M8 and 1M9. The above plurality of groups of coating lamp strips are tested, and the test results are as follows:

| | | Luminous | Color | Self- | | | | Test ambient | Test |
|---|---|---|---|---|---|---|---|---|---|
| Sample | White light | efficiency | temperature | absorption | | | Color | temperature | ambient |
| number | classification | (lm/W) | (K) | coefficient | SDCM | Ra | purity | (°) | humidity |
| 1M | ANSI_3500K | 34.95 | 3703 | 1.0426 | 6.6 | 91.7 | 33 | 25.3 | 65 |
| 1M1 | ANSI_3500K | 34.97 | 3703 | 1.0426 | 6.6 | 91.8 | 33 | 25.3 | 65 |
| 1M2 | ANSI_3500K | 34.99 | 3703 | 1.0426 | 6.6 | 91.7 | 33 | 25.3 | 65 |
| 1M3 | ANSI_3500K | 35 | 3701 | 1.0426 | 6.7 | 91.8 | 33.1 | 25.3 | 65 |
| 1M4 | ANSI_3500K | 35.03 | 3703 | 1.0426 | 6.6 | 91.7 | 33 | 25.3 | 65 |
| 1M5 | ANSI_3500K | 35.03 | 3703 | 1.0426 | 6.6 | 91.7 | 33 | 25.3 | 65 |
| 1M6 | ANSI_3500K | 35.04 | 3703 | 1.0426 | 6.6 | 91.7 | 33 | 25.3 | 65 |
| 1M7 | ANSI_3500K | 35.05 | 3701 | 1.0426 | 6.7 | 91.7 | 33 | 25.3 | 65 |
| 1M8 | ANSI_3500K | 35.07 | 3704 | 1.0426 | 6.6 | 91.7 | 33 | 25.3 | 65 |
| 1M9 | ANSI_3500K | 35.09 | 3704 | 1.0426 | 6.6 | 91.7 | 33.1 | 25.3 | 65 |

It can be seen from the above that, with reference to the coating material for the lamp strip provided by the present invention, the prepared coating lamp strip is good in luminous efficiency, small in SDCM, high in color purity, high in color rendering index, more than 90 in Ra value and excellent in performance.

Now, the sample IM is tested for lightening time, and the test results are shown in the table:

| | Lightening | Luminous | Color |
|---|---|---|---|
| Model | time | efficiency (lm/W) | temperature (K) |
| 1M | 0:00:00 | 7.75 | 3609 |
| 1M | 0:01:13 | 9.95 | 3636 |
| 1M | 0:02:02 | 12.24 | 3638 |
| 1M | 0:03:02 | 19.59 | 3660 |
| 1M | 0:04:02 | 25.61 | 3679 |
| 1M | 0:05:04 | 28.46 | 3691 |
| 1M | 0:06:01 | 30.04 | 3700 |
| 1M | 0:07:02 | 31.16 | 3702 |
| 1M | 0:08:00 | 31.95 | 3701 |
| 1M | 0:09:02 | 32.58 | 3702 |
| 1M | 0:10:04 | 33.08 | 3706 |
| 1M | 0:11:01 | 33.48 | 3704 |
| 1M | 0:12:02 | 33.83 | 3704 |
| 1M | 0:13:04 | 34.13 | 3703 |
| 1M | 0:14:01 | 34.38 | 3704 |
| 1M | 0:15:02 | 34.61 | 3704 |
| 1M | 0:16:00 | 34.81 | 3703 |
| 1M | 0:17:04 | 35.03 | 3703 |
| 1M | 0:18:01 | 35.17 | 3703 |
| 1M | 0:19:01 | 35.31 | 3702 |
| 1M | 0:20:02 | 35.43 | 3702 |
| 1M | 0:21:02 | 35.53 | 3701 |
| 1M | 0:22:02 | 35.64 | 3700 |
| 1M | 0:23:02 | 35.71 | 3699 |
| 1M | 0:24:03 | 35.77 | 3699 |
| 1M | 0:25:03 | 35.84 | 3696 |
| 1M | 0:26:03 | 35.91 | 3694 |
| 1M | 0:27:04 | 35.95 | 3696 |
| 1M | 0:28:04 | 36 | 3693 |
| 1M | 0:29:04 | 36.02 | 3693 |
| 1M | 0:30:01 | 36.04 | 3692 |
| 1M | 0:31:04 | 36.09 | 3689 |
| 1M | 0:32:00 | 36.09 | 3687 |
| 1M | 0:33:02 | 36.12 | 3688 |
| 1M | 0:34:04 | 36.14 | 3687 |
| 1M | 0:35:00 | 36.15 | 3685 |
| 1M | 0:36:02 | 36.16 | 3684 |
| 1M | 0:37:05 | 36.17 | 3682 |
| 1M | 0:38:00 | 36.17 | 3682 |
| 1M | 0:39:03 | 36.18 | 3679 |
| 1M | 0:40:05 | 36.19 | 3679 |
| 1M | 0:41:01 | 36.2 | 3678 |
| 1M | 0:42:03 | 36.2 | 3677 |
| 1M | 0:43:05 | 36.2 | 3676 |
| 1M | 0:44:06 | 36.2 | 3674 |
| 1M | 0:45:01 | 36.21 | 3674 |
| 1M | 0:46:04 | 36.21 | 3672 |
| 1M | 0:47:00 | 36.22 | 3670 |
| 1M | 0:48:02 | 36.23 | 3669 |
| 1M | 0:49:05 | 36.23 | 3667 |

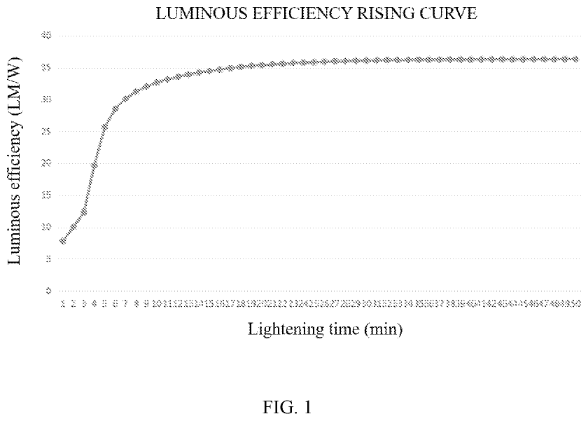

FIG. 1 shows a luminous efficiency rise curve.

It can be seen clearly from the chart shown in FIG. 1 and the above table that as the lightening time is longer, the temperature of the lamp body becomes higher, the light transmittance of the coating adhesive is increasingly higher, and the luminous efficiency of the coating lamp strip is increasingly higher accordingly. After being lightened for 5 minutes, the luminous efficiency of the coating lamp strip has reached above 30 LM/W, and the coating adhesive shows excellent light transmission performance.

It will be apparent to those skilled in the art that the present invention is not limited to the details of the above exemplary embodiments, and that the present invention can be embodied in other specific forms without departing from the spirit or essential characteristics of the present invention. The embodiments are therefore to be considered in all respects as illustrative and not restrictive, the scope of the present invention being indicated by the appended claims rather than by the above description, and all changes which fall within the meaning and scope of equivalency of the claims are therefore intended to be embraced therein. Any reference numeral in the accompanying drawings in the claims should not be regarded as limiting the claims involved.

In addition, it should be understood that although the description is described according to implementations, not each implementation only contains an independent technical solution, the description is narrated in this manner for clarity only, those skilled in the art should treat the description as a whole, and the technical solutions in each embodiment can be appropriately combined to form other implementations that those skilled in the art can understand.

What is claimed is:

1. A coating lamp strip capable of improving luminous efficiency, comprising a light source strip, and a coating adhesive that externally covers/encapsulates the light source strip, wherein the coating adhesive is made of an extrudable organo-silicon elastic material, which is black or gray at normal temperature, has a temperature-sensing characteristic, may change color as temperature increases, and gradually changes from black to white-like.

2. A coating material for a lamp strip, comprising the following raw materials in parts by mass:

| | | |
|---|---|---|
| siloxane composition | 95-97 | parts |
| diffusion agent | 2-5 | parts; |

then, temperature change powder with a proportion of 1.5-2% was added on the basis of the total number of the parts by mass.

3. The coating material for a lamp strip according to claim 2, wherein the siloxane composition comprises the following raw materials in parts by mass:

| | | |
|---|---|---|
| polysiloxanes, di-me, me vinyl, vinyl group-terminated | 50-95 | parts |
| silicon dioxide | 5-50 | parts |
| hydroxyl-terminated polydimethylsiloxane | 0-0.8 | parts |
| auxiliary agent | 0.3-0.8 | parts. |

4. The coating material for a lamp strip according to claim 2, wherein the diffusion agent comprises the following raw materials in parts by mass:

| | | |
|---|---|---|
| organo-silicon polymer | 15-20 | parts |
| diffusion powder | 70-75 | parts |
| structural agent | 6-8 | parts |
| dispersing agent | 2-4 | parts. |

5. The coating material for a lamp strip according to claim 4, wherein the organo-silicon polymer is polydimethylsiloxane.

6. The coating material for a lamp strip according to claim 4, wherein the diffusion powder is quartz powder.

7. The coating material for a lamp strip according to claim 4, wherein the structural agent is room temperature vulcanized silicone rubber.

8. The coating material for a lamp strip according to claim 4, wherein the dispersing agent is dimethicone.

9. The coating material for a lamp strip according to claim 2, wherein the temperature change powder comprises the following raw materials in parts by mass:

| | | |
|---|---|---|
| isobutylphenoxy epoxy resin | 40-60 | parts |
| fatty acid compound | 50-70 | parts |
| color-changing dye | 1-10 | parts |
| color developing agent | 1-10 | parts |
| auxiliary agent | 1-10 | parts. |

10. A preparation method for a coating lamp strip capable of improving luminous efficiency, wherein a process comprises the following steps:
step A: preparing a light source strip;
step B: preparing a siloxane composition, a diffusion agent, and temperature change powder, and mixing a coating adhesive through a mixer;
step C: placing the light source strip into a forming mould on an extruder, starting the extruder and feeding a mixed coating adhesive, and extruding a coating adhesive film until the coating adhesive film uniformly wraps the light source strip;
step D: starting a vacuum film coating device to completely and tightly attach the coating adhesive film and to coat the light source strip; and
step E: feeding the film-coated light source strip into a constant-temperature furnace for curing and molding, wherein the temperature of the constant-temperature furnace is 140° C.-180° C.
